(19) United States
(12) Patent Application Publication
(10) Pub. No.: US 2015/0039417 A1
(43) Pub. Date: Feb. 5, 2015

(54) METHOD, COMPUTER SYSTEM AND DEVICE FOR DETERMINING EFFECTIVENESS OF AN ONLINE ADVERTISEMENT

(71) Applicant: Hurra Communications GmbH, Stuttgart (DE)

(72) Inventor: Rene Schweier, Stuttgart (DE)

(73) Assignee: Hurra Communications GmbH, Stuttgart (DE)

(21) Appl. No.: 13/958,702

(22) Filed: Aug. 5, 2013

(51) Int. Cl. G06Q 30/02

(52) U.S. Cl. CPC G06Q 30/0246
USPC 705/14.45

(57) ABSTRACT

A method is disclosed for determining effectiveness of an online advertisement displayed on a first network page. The advertisement refers to at least one of an online shop, a product and a service offered by an online shop. The method include the steps of selecting a group of network users and presenting the online advertisement to a first number of users of the group of network users requesting the first network page, not presenting the online advertisement to a second number of users of the group of users requesting the first network page, assessing each user of the first number of users and of the second number of users with respect to at least one criteria and based on results of the assessment of the users, determining the effectiveness of the online advertisement on the first network page by comparing the user assessment results for the first number of users with the user assessment results for the second number of users.

### BACKGROUND OF INVENTION

1. Field of Invention

The present invention concerns a method, a computer system and a device for determining effectiveness of an online advertisement displayed on a first network page, the advertisement referring to at least one of an online shop, a product and a service offered by an online shop.

The invention also concerns a computer system having a computer readable storage device containing instructions for controlling the method.

2. Description of the Related Art

A computer which is connected to the communications network is, for example, called a server or web server and runs software to enable the server to provide certain services. These services may be, for example, providing information or resources (e.g. storage space, calculation capacity or access to a communications network). The communications network may be, for example, the Internet or a private local area network.

The services are typically used by a so-called client. Towards this end, the client transmits a request to the server using a communications network. The server evaluates the incoming request, optionally checks whether the client is authorized to issue the request and transmits information in correspondence with the request or provides the required resources.

Information is often provided by a server to a client in the form of so-called network pages (also called Internet pages, web pages or briefly pages). A set of related web pages served from a single web domain is called a website. A website is hosted on at least one web server, accessible via the communications network through an Internet address known as a Uniform Resource Locator (URL). All publicly accessible websites collectively constitute the World Wide Web (WWW).

To describe the content of a network page, a language describing the page is used. The standardized page-describing language HTML (Hypertext Markup Language) is mainly used today. HTML permits simple description of the content and appearance of a network page in a so-called HTML document. If a client requests, for example, information from a server, the server transmits a HTML document containing the requested information to the client. If the information transmitted to the client by means of the HTML document is to be displayed to a user, the network page or the HTML document is transmitted to a special computer program (a so-called browser), which can interpret HTML documents and display them on a computer monitor using a graphic interface.

The network pages transmitted by the server to the client may already be generated before the client's request and be stored at a suitable location. Such network pages are called static network pages.

Often, a client will place a specific request to the server such that the network pages containing the requested information are dynamically generated by the server in the very instant of the request. This is the case, for example, when a user uses the client to transmit a request in the form of a search term to a server designed as or making part of a search engine. The search engine gathers information, which is associated with the search term, in accordance with a predefined algorithm on the basis of the search term. Usually, the search engine scans the entire WWW at predetermined points in time and gathers information about the accessible websites. This information is usually stored in large storage devices and is accessed for gathering the requested information associated with the search term transmitted by the user. Depending on the gathered information, a dynamic network page is automatically created by the server and transmitted to the client. A dynamic web page can contain, for example, a search result or a hit list relating to the transmitted search term.

A plurality of clients and servers communicate via the Internet, and together they form a multi-media information system, the so-called WWW. Network pages available within the WWW can be addressed via an URL (Uniform Resource Locator). A URL is usually composed of the name of the server providing the network page, a register and a name associated with the network page. A URL permits direct selection of the network page associated with this URL by a client. Towards this end, a user may enter the URL into a specific input field of the browser. The client subsequently generates a request to the corresponding server which then transmits the requested network page to the client.

URLs of further network pages or HTML documents can be mentioned within an HTML document. Such URLs are called links or hyperlinks (briefly: link). Links shown on static network pages are referred to below as static links. Analogous thereto, links shown on dynamic network pages are referred to below as dynamic links.

If links are displayed to a user via a browser, the user can select a displayed link and have the network page displayed which corresponds to the selected URL simply by clicking on the link with his input device, for example, with a computer mouse. The selected network page may, in particular, also be located on another server separate from the first server of the online shop and separate from the second server providing the requested network page on which the link is displayed.

A second server is often instructed by a first server to provide a link to a network page of the first server via network pages which are transmitted to a client by the second server. Such a link may be part of an online advertisement including contextual ads on search engine results pages, banner ads, blogs, rich media ads, social network ads, interstitial ads (a web page displayed before or after the expected content page), online classified ads, advertising networks (companies connecting advertisers to web sites that want to host advertisements. The key function of an ad network is aggregation of ad space supply from publishers and matching it with advertiser demand), dynamic banner ads, and cross-platform ads. Such online advertisements may advertise a product or service offered by the first server which can be obtained via the first server using a written and/or graphic representation. The link shown on the second network page is thereby typically associated with text, sound and/or graphic elements which are displayed to the user using the browser. The term “link” therefore also comprises the entire information associated with the link.

A product may also, in particular, be information offered by the first server. The product may moreover be an access to a protected storage region provided by the first server, which contains further accessible information. Such information may be, for example, news, stock market prices, as well as other text, sound or image data. Preferably, the product or service is offered by an online shop associated to the first server. This type of selling products or services via the Internet is also called e-commerce (electronic commerce).

The information transmitted by the second server to the client, for example the hit list from a search engine, is often distributed on several network pages, wherein only one first network page of these several network pages is initially transmitted to the client. The client then successively requests one of the further of these network pages from the second server, for example by clicking on a link provided on the first network page or by entering the further network pages' network address into the browser.

If the second server is a search engine or is assigned to or makes part of a search engine, the first server can instruct the second server to display a link to a network page associated with the first server on a network page generated in dependence on a search term entered by a user. In that case the second server would provide a second network page in the form of a hit list or a search result to the client. The hit list displayed to the user would comprise a link, for example, some kind of online advertisement, to the network page associated with the first server. If the first server was an online shop or was assigned or made part of an online shop, the online advertisement could advertise the online shop or a certain product or service offered by the online shop. Hence, if the user clicked on the link, he would be displayed the first network page of the online shop, for example the so-called landing page or any other page referring to the advertised product or service.

Landing pages are often linked to from social media, email campaigns or search engine marketing campaigns in order to enhance the effectiveness of the advertisements. The general goal of a landing page is to convert site visitors into sales leads. By analyzing activity generated by the linked URL, marketers can use click-through rates and conversion rates (how many clicks actually create business and how much business do they create) to determine the success and effectiveness of an online-advertisement. This is described, for example, in U.S. Pat. No. 8,301,747 B2.

Under usual circumstances, the higher the number of links is, which are displayed on a network page transmitted to a client via a second server, the larger the amount of network page data to be transmitted. This increases the load on the communications network. This is further increased if, due to the plurality of links, several network pages are transmitted to the client via the second server. Moreover, a network page containing one or several links requires more storage space on the transmitting second server as well as on the receiving client.

In particular, if the second server is designed as a search engine, the information which is generated by the search engine in dependence on a search term transmitted to the server by the client consists of a list of links to network pages which are provided by other servers. To increase the relevance of the information and links provided by a search engine in response to a request, this information, links and search terms are conventionally classified through computer linguistic methods and these classes are mutually associated. The search engine selects suitable information and links through association of classified search terms and information on the basis of a search term received by a client.

An online shop can book certain search terms (so-called keywords) with the second server or the provider of the second network page in order to have desired links to the online shop or to one of its network pages displayed on the second network page if the search term entered by the user corresponds to the booked keyword. This is called keyword advertising and is known, for example, from Google® AdWords® or Bing® Ads. The more the online shop pays for booking the keyword the higher ranked are the links on the second network page. Higher ranked links are potentially more attractive to the user and will potentially result in a higher conversion rate (see, for example, http://support.google.com/adwords/answer/2404261?h1=en&ref_topic=1713975).

The online shop usually pays for booking keywords on a pay-per-click basis. The amount to be paid is usually not static but will be determined dynamically in the course of an auction or a bidding process. Hence, keywords in great demand and a higher ranking of a link on the second network page are more expensive than keywords slow in demand and having a low ranking. Known keyword optimization processes determine the value of a keyword and assess the link connected to the keyword by analyzing commercial activity generated by the linked URL (see U.S. Pat. No. 8,301,747 B2). Hence, if a link is successful because it generates a relatively large amount of commercial activity, the online shop can offer a higher price for booking the keyword and/or for obtaining higher ranking of the link on the second network page. On the other hand, if a link is less successful because it generates a relatively small amount of commercial activity, the online shop will offer less for booking the keyword and/or will be satisfied with lower ranking of the link (see, for example, http://support.google.com/adwords/answer/1704424?hl=en&ref_topic=2642398). All an advertiser has to do is to enter the desired key words, a respective maximum bidding price and an overall maximum budget for advertisement within a predetermined time period. The online-bidding system automatically assigns the location of the various links on the second network page (e.g. the SERP, search engine result page) according to the respective maximum bidding prices.

In the prior art (e.g. U.S. Pat. No. 8,301,747 B2) the link to the first network page is optimized based on the number of conversions which are actually realized by the link. Towards this end, a result of assessing the link is a numerical value and optimization of the link is performed depending on a comparison of the numerical value to at least one threshold value. This is how Google® AdWords® “Bid Ideas” works (see, for example, http://support.google.com/adwords/answer/2404205?h1=en&from=171937&rd=1). However, it has turned out that it is extremely difficult, if not impossible, to determine correct threshold values, which allow a correct and reliable assessment of the link.

The number of requests answered by a server depends, among others, on the amount of network page data which is transmitted per request by the server to the requesting client. Static network pages must be read from a storage device, for example, by the server. To generate dynamic network pages, the respective content (information) must be read out of the storage device and be integrated into the network page. The network pages are then processed in dependence on the layers of a network protocol used for data transmission (e.g. TCP/IP). This means, the larger the amount of data for a request to be transmitted by a server, the lower the available performance of the server for further, imminent requests.

The network pages are transmitted by the server to the client using the communications network. The amount of data which can be transmitted by the communications network per unit time is thereby limited.

The client initially processes a received network page in dependence on the network protocol used and stores the network page in a suitable storage region. The browser will subsequently process the network page such that the information can be displayed on a monitor.

To minimize load on the calculation power and the storage capacities of the server and of the client, and to relieve the communications network through transmission of a minimum data amount, it is desirable to only display links on the network page generated by the search engine which are actually of interest to the client or the user.

Finally, current methods for optimizing effectiveness of an online advertisement are restricted to a certain service provider managing content and display of the second network page. For example, it is well known in the art to optimize online advertisement on a search engine's web page containing a hit list or search result. In particular, the maximum bidding price which the online shop offers for having its online advertisement placed on the search engine's web page can be optimized by adapting the maximum bidding price to the effectiveness of the online advertisement. For example, if a high ranked online advertisement increases the turnover in the online shop only slightly, in future the online shop will offer a lower maximum bidding price and, consequently, the online advertisement will be lower ranked in future. However, current optimization processes are limited to certain service providers, for example certain search engine providers.

Therefore, what is clearly needed is a possibility to optimize online advertisement independent of the service provider and allowing automatic optimization of online advertisement presented on web pages of different service providers. Furthermore, what is desired is a possibility to provide for a correct and particularly reliable assessment of the online advertisement. Finally, it is desired to minimize load on the calculation performance of the server and of the client, and on the transmission performance of the communications network and to permit optimum utilization thereof through reduction of the amount of network page data. It is therefore the underlying purpose of the invention to only permit display of online advertisement on a network page of a server which is of interest to a client or user.

### SUMMARY OF THE INVENTION

This purpose is achieved in accordance with the invention with a method for determining effectiveness of an online advertisement displayed on a first network page, the advertisement referring to at least one of an online shop, a product and a service offered by an online shop, the method comprising the steps of:
a) selecting a group of network users;
b) presenting the online advertisement to a first number of users of the group of network users requesting the first network page, thereby storing a cookie on each client of the first number of users, each cookie comprising a unique user ID for the respective user;
c) not presenting the online advertisement to a second number of users of the group of users requesting the first network page, thereby storing a cookie on each client of the second number of users, each cookie comprising a unique user ID for the respective user;
d) assessing each user of the first number of users and of the second number of users with respect to at least one criteria; and
e) based on results of the assessment of the users, determining the effectiveness of the online advertisement on the first network page by comparing the user assessment results for the first number of users with the user assessment results for the second number of users.

In accordance with the present invention, the effectiveness of an online advertisement is automatically determined by presenting the online advertisement to a first number of users of a predefined group of users and not presenting the online advertisement to a second number of users of the predefined group of users. The first and second number of users is selected in order to allow a representative survey on the influence of the online advertisement on the group of users. For example, the first and second number of users may comprise at least several hundred users of the group of users. Furthermore, preferably, the first and second number of users is approximately the same. Alternatively, the first and second number of users is taken into account when determining the effectiveness of the online advertisement.

Preferably, the group of network users is selected such that all users of the group have at least one characteristic in common. This characteristic can, for example, comprise the users' sex, age, place (e.g. country, town, urban quarter, street) of domicile, nationality, marital status, number of children, special interests and hobbies, and online shopping behavior or any combination thereof. The online shopping behavior may comprise the type of products or services which the user usually purchases online, the overall online turnover the user generates in total or in a certain online shop, a season, day, time of day the user usually goes online for shopping, etc.

From this group of network users having similar characteristics the first number of users and the second number of users is selected. The online advertisement is presented to the first number of users on the first network page when they request that page. The online advertisement may be one of a textual, graphical or audio advertisement. In particular, the online advertisement may be one of contextual ads on search engine results pages, banner ads, blogs, rich media ads, social network ads, interstitial ads, online classified ads, advertising spots, and advertising networks. The online advertisement may comprise or may be associated to a link to a second network page of the online shop to which the online advertisement refers to.

For example, the first network page can be requested by a user by entering a network address associated to the first network page into a browser running on the user's client, by clicking on a hyperlink displayed on a second network page previously presented to the user or by automatically forwarding the user from a second network page previously presented to the user to the first network page. In particular, a user can request the first network page by entering a search term or search string in a search engine's web page and triggering an Internet search. The first web page is then dynamically created and presented to the user as a hit list or as search results. The online advertisement would then be presented on that web page. Similarly, if a user of the second number of users requests the same web page, the online advertisement would not be presented to the user.

Then, each user of the first number of users and of the second number of users is assessed with respect to at least one criteria. The criteria may comprise, for instance, at least one of whether the user enters the online shop at all, how long the user remains in the online shop, and a turnover generated by the user upon entry into the online shop. Assessment of the users is preferably performed based on information stored in the cookies previously set on the users' clients and possibly updated during the users' previous online activity. A cookie is generated by the referring network server and/or by the online shop's server and is stored at the client. If the client once more requests a network page from the referring server or the online shop's server, the cookie generated by the respective server is transmitted by the client to that server. The server can thereby determine which client or user requests a certain network page producing statistic information concerning the request frequency of the network page by a client or user. This permits the server to provide client or user-specific information and, in particular, design the selection and representation of the network page transmitted to the client in a client or user-specific manner. Statistics on the frequency of the network pages requested by a client or user is an example of user information. User information could, in particular, also be called client information. A cookie stored on the user's client can contain any kind of user or client information.

For example, a user ID is stored in the cookie and each time the user enters the online shop appropriate information is stored in the cookie. This information may comprise a simple counter for counting the number of times the user has entered the online shop, information corresponding to a time period how long the user remains in the online shop, information on the products and/or services the user has shown interest in during his stay in the online shop, information on the products and/or services the user buys in the online shop, and a turnover generated by the user upon entry into the online shop. Of course, this information does not have to be stored directly in the cookie. Preferably, the cookie contains information about at least one of the first network page (e.g. associated with a search engine or any other kind of content provider), another network page (e.g. associated with an advertiser or an online shop) and the user. The cookie typically also comprises date and running time. Furthermore, a cookie set by a search engine's server can comprise one or more search terms entered by the user. Further, cookies set by the online shop's server can contain information regarding the user's shopping behavior, in particular products or services he has shown interest in during one of his last visits to the online shop, products or services he has bought during one of his last visits to the online shop, the overall turnover generated by the user in the online shop, etc.

In order to reduce the cookie's size and to keep delays for updating the information stored in the cookie as short as possible, preferably, the cookie comprises the user ID and a reference referring to a network server, where all the above mentioned information is stored for that user ID.

Of course, it is possible and advantageous if the network server contains the above mentioned information for a plurality of user IDs. In that way the storage space required for the cookie on the users' clients and the amount of data to be transmitted to and from the users' clients can be significantly reduced. The information to be stored at the network server the cookie refers to is simply transmitted from a first server associated with the online shop and connected to a communications network to the network server the cookies' information is stored across a communications network. There is no need for forwarding the information to the clients via the communications network and to store them there.

Preferably, when assessing each user of the first number of users and of the second number of users the characteristic for selecting the group of users is taken into consideration, too. This characteristic comprises at least one of sex, age, place of domicile, nationality, marital status, number of children, special interests and hobbies, and online shopping behavior.

Finally, based on results of the assessment of the users, the effectiveness of the online advertisement on the first network page is determined. This is preferably performed by comparing the user assessment results for the first number of users with the user assessment results for the second number of users. In particular, the conversion rate of the first number of users is compared to conversion rate of the second number of users in order to determine the effectiveness of the online advertisement. In order to make comparison of the conversion rates of the first and second numbers of users easier and faster, the conversion rates of the first and second number of users are preferably statistically evaluated before comparing them with one another. Of course, the effectiveness of the online advertisement can be determined depending on the characteristic also used for selecting the group of users, that is depending on sex, age, place of domicile, nationality, marital status, number of children, special interests and hobbies, and/or online shopping behavior of the users.

Hence, the effectiveness of the online advertisement is not assessed in respect to absolute threshold values but rather in respect to relative values obtained through assessment of the users belonging to the different first and second number of user. This allows a particularly accurate and reliable determination of the effectiveness of the online advertisement when displayed on the first network page.

If the first network page is a hit list or a search result of a search engine, the first network page is dynamically generated by a first server depending on the search term or search equation entered by the user and then transmitted upon triggering of the online search by the user to the user's client where it is displayed in a browser. The online advertisement will be displayed to the first number of users on the search engine's network page together with or as part of the search results. The search engine's network page will be displayed without the online advertisement to the second number of users. After assessment of the users of the first number of users and of the second number of users the effectiveness of the online advertisement can be determined.

In particular, for each user to be assessed the conversion rate is determined. For example it is determined if the user's status turns from a user to a client of the online shop, from a user of a search engine to a visitor of the online shop's network page, or if a visitor of a network page is converted into a contact request. If the online advertisement is effective the first number of users will have a much higher conversion rate than the second number of users. In that case the online advertisement can be further presented on the first network page. A higher or the previously offered maximum bidding price for a higher or the same ranking presentation of the online advertisement on the first network page is reasonable. If, however, the online advertisement is less effective the first number of users will have only a slightly higher, the same or even a lower conversion rate than the second number of users. In that case the online advertisement can be either further presented on the first network page but at a lower rank or not displayed on the first network page any more. In that case a relatively high maximum bidding price for a higher ranking presentation of the online advertisement on the first network page is not reasonable. Therefore, the maximum bidding price will be reduced and could even arrive at zero (no future display of the online advertisement on the first network page).

In a preferred embodiment, the results of step e) are further used for calculating a maximum bidding price for the online advertisement, which the online shop would pay in future for having the online advertisement presented to users on the first network page. Preferably, the calculated maximum price is the maximum bid the online shop would offer in an online-bidding system for having the online advertisement presented to users on a search engine's hit list in connection with a given search term. Depending on the maximum bidding price the search engine providers decides online and almost in real-time whether to display the online advertisement on the network page or not and if it is displayed at which rank or position it will be displayed. Such an online-bidding system is, for example, Google®'s AdWords (see http://support.google.com/adwords/answer/1704424?hl=en&ref_topic=2642398). Hence, if a user requests the first network page, the bidding process is executed in the background unnoticed by the user and within milliseconds it is decided whether and in which position the online advertisement is to be presented on the first network page, and finally the network page is transmitted to the user's client together with the online advertisement and displayed together at the client by means of the browser.

With search engines, advertisers like an online shop, typically bid on search terms or keyword phrases relevant to their target market. Content sites commonly charge a fixed price per click (PPC) rather than use a bidding system. PPC “display” advertisements, also known as “banner” ads, are shown on web sites or search engine results with related content that have agreed to show ads. Websites that utilize PPC ads will display an advertisement when a keyword query matches an advertiser's keyword list, or when a content site displays relevant content. Such advertisements are called sponsored links or sponsored ads, and appear adjacent to, above, or beneath organic results (the hit list) on search engine results pages, or anywhere a web developer chooses on a content site. According to the present invention, the results of step e) can also be used for calculating a maximum price for that type of online advertisement, too, or for deciding whether to display an online advertisement on the content provider's network page at all. If the online advertisement is not to be displayed on the content provider's network page, the maximum price offered for future presentations of the advertisement on that network page is preferably reduced to zero.

In online bidding systems, the advertiser (i.e. the online shop) signs a contract that allows him to compete against other advertisers in a private auction hosted by a publisher or, more commonly, an advertising network. Each advertiser informs the host of the maximum amount that he is willing to pay for a given online advertisement (e.g. ad spot) often based on a keyword, usually using online tools to do so. The auction plays out in an automated fashion every time a user triggers the online advertisement. When the online advertisement is part of a search engine results page (SERP), the automated auction takes place whenever a search for the keyword that is being bid upon occurs. All bids for the keyword that target the searcher's geo-location, the day and time of the search, etc. are then compared and the winner determined. In situations where there are multiple online advertisements, a common occurrence on SERPs, there can be multiple winners whose positions on the network page are influenced by the amount each has bid. The advertisement with the highest bid generally shows up first, though additional factors such as ad quality and relevance (so-called quality score) can sometimes come into play.

In addition to online advertisement on SERPs, the major advertising networks allow for contextual ads to be placed on the properties of third parties with whom they have partnered. These publishers sign up to host ads on behalf of the network. In return, they receive a portion of the ad revenue that the network generates, which can be anywhere from 50% to over 80% of the gross revenue paid by advertisers. These properties are often referred to as a content network and the ads on them as contextual ads because the ad spots are associated with keywords based on the context of the network page on which they are found. In general, online advertisements on content networks have a much lower click-through rate (CTR) and conversion rate (CR) than ads found on SERPs and consequently are less highly valued. Content network properties can include websites, newsletters, and e-mails.

Advertisers pay for each click they receive, with the actual amount paid based on the amount bid. It is common practice amongst auction hosts to charge a winning bidder just slightly more (e.g. one penny) than the next highest bidder or the actual amount bid, whichever is lower.

To maximize success and achieve scale, automated bid management systems can be deployed. These systems can be used directly by the advertiser (i.e. the online shop), though they are more commonly used by advertising agencies that offer PPC bid management as a service (i.e. a third party acting in the name of and/or for the online shop). These tools generally allow for bid management at scale, with thousands or even millions of PPC bids controlled by a highly automated system. The system generally sets each bid based on the goal that has been set for it, such as maximize profit, maximize traffic at breakeven, and so forth. The system is usually tied into the advertiser's website and fed with the results of each click, which then allows it to set bids. According to the proposed embodiment, the maximum bidding prize offered by the advertiser (i.e. the online shop) or the third party for a certain keyword for having the online advertisement displayed on a certain network page (e.g. SERP), when a search term corresponds to the keyword, is calculated depending on the results of step e).

If the online advertisement is associated to a link, it is further suggested that, before determining the effectiveness of the online advertisement in step e), the number of activations of the link per user for the plurality of first and second number of users is weighted based on the results of step d) and wherein the effectiveness of the online advertisement is determined in step e) based on the weighted number of activations of the link. Weighting the online advertisement allows considering additional factors such as ad quality and relevance (so-called quality score) for assessment of the link.

The assessment of the users is preferably carried out in dependence on at least one process initiated by the user on the online shop's server. This embodiment is advantageous in that the evaluation does not only depend on the frequency of activation of a link associated to the online advertisement but also takes into consideration actions of the user on the online shop's server. A user can thereby be prevented from activating a link (which increases the frequency of activation) and then interrupting the loading of the first network page, which would produce false results. In particular, this embodiment provides particularly detailed and reliable evaluation results.

The process initiated by the user on the first server may be, for example, buying a product, requesting a service, information and/or a further network page associated with the first server. Furthermore, the process may be, for example, the time the user remains on the first server looking at the products and services offered by the online shop, a number of products and services the user looks at, an overall turnover generated by the user in the online shop by buying certain products and/or services at the online shop. These types of processes are particularly suited to indicate actual interest of the user and are therefore particularly suitable to display links in dependence on the interest of the user thereby saving storing space and calculation time while preventing unnecessary load on the communications network.

Source information is preferably automatically stored during activation of a link associated to the online advertisement and the effectiveness of the online advertisement is evaluated in dependence on the source information. The source information (so-called referrer) indicates on which network page an activated link was displayed. The referrer of the link which is displayed on the first network page and which refers to the online shop's network page is, for example, the URL associated with the first network page. This information is also transferred during activation of a link. It is thereby possible for the online shop's server to determine the server which has transmitted the first network page to the client on which the link to the online shop's network page was represented. The online shop's server can thereby moreover differentiate whether a client has directly requested the online shop's network page, for example, through direct selection of the URL associated with the network page using the browser, or whether the client has requested the online shop's network page through activation of a link shown on the first network page. The source information can be stored in a cookie on the user's client. This can be the same cookie also containing information about at least one of the first network page and the user or a different cookie. Of course, the source information could also be stored on a network server, to which the cookie refers to.

The users are preferably automatically assessed also on the basis of the source information and/or user information. Towards this end, the user is advantageously associated with a user ID. A user ID may e.g. be automatically generated by the referring server and/or the online shop's server on the basis of information which is transferred by the client associated with the user during inquiry of a network page. The user ID may, in particular, be a characterization of the client, e.g. his/her IP address (Internet Protocol Address).

The user may also be assessed with respect to other criteria. These criteria state, for example, the time period over which a user has been using the services of the online shop's server (customer duration), the amount of information or services exchanged between the online shop's server and the user (turnover), the payment behavior of the user or how many services or how much information were requested by the user (orders).

In a preferred further embodiment of the invention, the result of the assessment of the users and/or of the determination of the effectiveness of the online advertisement is automatically stored in such a manner that it can be recalled for a specific user or group of users. The specific user may e.g. be the operator of the online shop's server or the operator of a different network server (i.e. the advertiser). The information may be represented to the specific user on special network pages which are generated by the second server via a so-called port. Such network pages are typically automatically generated by the second server and therefore permit the user to obtain an overview of the assessment of individual users and/or online advertisements in a particularly user-friendly manner. Preferably, the special network pages present the information graphically to the specific user.

In a preferred embodiment of the invention it is suggested, based on the effectiveness of the online advertisement, to determine for future requests of the first network page whether to display the online advertisement to a user requesting the first network page or not. Preferably, in case during future requests of the first network page the online advertisement is not presented to a user requesting the first network page, the online advertisement is presented to a user requesting another network page. With other words, if the online advertisement proves to be inefficient, money is no longer spent or less money is spent for display of the online advertisement on the first network page. The money saved can be invested in online advertisement on other network pages, preferably on network pages provided by other service providers different from those of the first network page. Hence, the invention allows a dynamic allocation of the online advertisement budget in order to optimize the advertisement efficiency. This may be performed automatically, for example, by a network server, or manually by the user.

In particular for search engines, the online advertisements are shown on the first network page in dependence on requests defined by the search terms. For example, depending on the result of the evaluation of the efficiency of the online advertisement, it could be decided to no longer display the online advertisement on the search engine's network page (SERP) but on the network page of a different search engine or of some other kind of different content provider. The operator of the online shop's server (i.e. the advertiser) may be interested to stop showing a certain online advertisement on a certain network page should the assessment of the users' online behavior show that the online advertisement is ineffective, for example because a link associated with the online advertisement is activated only rarely and/or because the online advertisement produces no considerable turnover. Alternatively, the advertiser may decide to display the online advertisement on a different network page, preferably of a different search engine provider.

Presenting the online advertisement on a different network page of the same search engine provider could be realized, for example, by booking one or more different search terms (so-called keywords) with the search engine server or the search engine provider in order to have the online advertisement displayed on the corresponding network page if the search term entered by the user corresponds to the booked keyword. Due to the fact that search engine network pages containing search results or hit lists are dynamically generated depending on the search term, having booked different keywords would mean that the online advertisement is displayed on different network pages.

The effectiveness of the online advertisement is advantageously also assessed in dependence on at least one piece of information with respect to the product or service or to the product group or group of services associated with the online advertisement. Such information is, for example, the availability of a product or service or a parameter which states whether a product group or group of services is currently available as a special offer. This permits a more precise decision as to whether it is worth it to continue to display a certain online advertisement on the first network page or whether it may be advantageous in point of efficiency of advertisement to display the advertisement on another network page, preferably of a different content provider than the first network page.

In a preferred embodiment, the at least one piece of information about the product, product group, service and/or group of services is information from a merchandise information system. Such a merchandise information system preferably provides information about the identification, availability, sales prices, profit portion, turnover achieved, the number of cancellations, the number of returns, the number of product deficiencies, the number of non-payments and/or advertising costs. This embodiment provides a particularly effective assessment concerning whether and how a link should be displayed on a network page provided by the second server.

The information with respect to the product, product group, service and/or group of services is preferably automatically determined by the online shop's server which permits particularly fast performance of the inventive method. The online shop's server may thereby, for example, automatically obtain or request the required information from an (automated) merchandise information system. Alternatively, the method according to the invention may also be executed on a network server, to which the online shop server has access and which controls the content (e.g. search engine) server, thereby influencing presentation of the online advertisement to the users.

The advantages of the inventive computer system are, in particular, an increase in the efficiency of the overall computer system, since the amount of data to be processed, stored and transmitted is reduced.

The components of the computer system for carrying out the inventive method are advantageously programmed.

The realization of this invention in the form of a computer program is particularly important. The computer program can be run on at least one calculating device or a computer, in particular, on a server, and is programmed to carry out and/or control the inventive method. Parts of the computer program may be run on different computers in order to carry out the inventive method. The different computers are preferably interconnected by means of a local area network, in particular by the Internet. The invention is thereby realized by the computer program, wherein this computer program represents the invention in the same sense as the method for the execution of which, the computer program is suitable.

The computer program is preferably stored on a storage element. A storage element may, in particular, be a Random-Access-Memory, a Read-Only-Memory or a Flash-Memory, a USB-stick, a CD-ROM or a DVD. Furthermore, the computer program could also be stored on a network server ready for download by an authorized person.

Further features, possible applications and advantages of the invention can be extracted from the following description of embodiments of the invention which are shown in the drawing. All the features described or shown constitute subject matter of the invention either individually or in arbitrary combination irrespective of their combination in the claims or their dependencies and irrespective of their formulation or representation in the description or in the drawing.

### BRIEF DESCRIPTION OF THE DRAWINGS

FIG. 1 shows an inventive computer system;

FIG. 2 shows an inventive computer system, wherein the third server is designed as software;

FIG. 3 shows an example of a flow chart of the inventive method;

FIG. 4 shows an example of a flow chart of the inventive method, wherein the second server is designed as a search engine; and

FIG. 5 shows a schematic representation of method steps for optimizing an assessed link.

### DESCRIPTION OF THE PREFERRED EMBODIMENTS

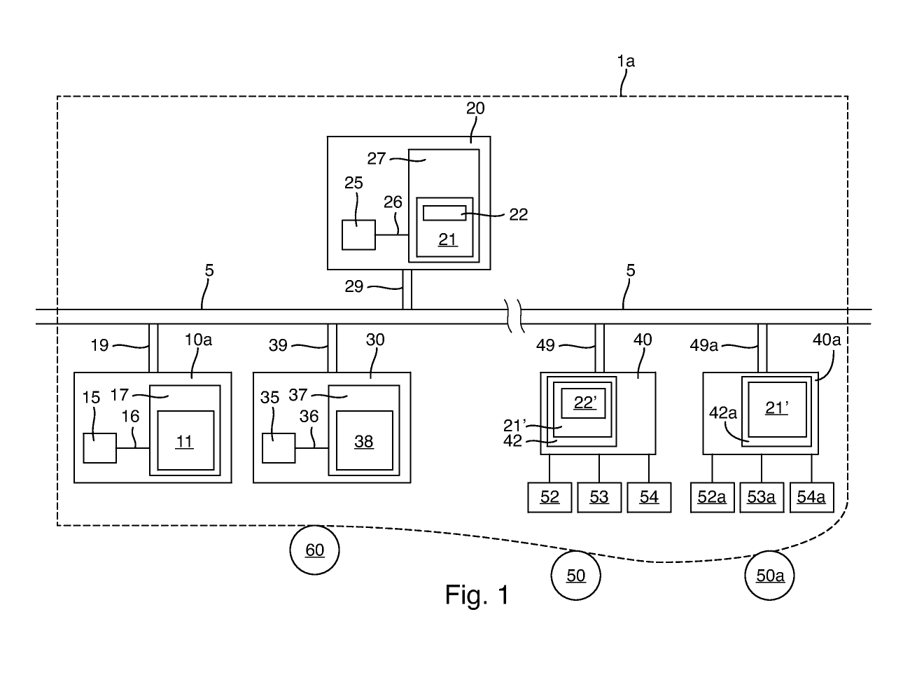

FIG. 1 shows a computer system 1a in a preferred embodiment of the invention. A first server 20 comprises a processor 25 and a storage element 27 connected to the processor 25 via a bus system 26. A first network page 21 is stored in the storage element 27 which comprises an online advertisement 22. The online advertisement 22 may comprise different types of online advertisement, preferably be one of a textual, graphical or audio advertisement. In particular, the online advertisement 22 may be of the type of one of contextual ads on search engine results pages, banner ads, blogs, rich media ads, social network ads, interstitial ads, online classified ads, advertising spots, and advertising networks. The online advertisement 22 may comprise or may be associated to a link referring to another network page 11 of an online shop to which the online advertisement refers to.

The first server 20 is connected to a communications network, e.g. the Internet 5, via a data line 29. The first server 20 is preferably associated with a search engine, in which case the first network page 21 could be a search engine result page (SERP). The online advertisement is presented on the first network page 21 according to certain presentation characteristics. The presentation characteristics comprise, for example, a search term associated with the online advertisement 22, an online shop, a product or a service, to which the online advertisement 22 refers to, and on which first network page 21 the online advertisement 22 is presented.

A second server 10a has a processor 15 and a storage element 17 connected to the processor 15 via a bus system 16. A second network page 11 is stored in the storage element 17. The second server 10a is connected to the communications network, e.g. the Internet 5, via a data line 19. The second server 10a is preferably associated with an online shop offering products, product groups, services and/or groups of services for sale or rental on the Internet 5. In that case the second network page 11 could be a landing page offering a specific product, product group, service or group of services.

A third server 30 comprises a processor 35 and a storage element 37 connected to the processor 35 via a bus system 36. A computer program 38 is stored in the storage element 37. The computer program 38 realizes e.g. the functionality of the inventive device, i.e. in particular, the determination of the effectiveness and the optimization of the online advertisement 22 and/or causes changes in the presentation of the online advertisement 22 on a network page. The third server 30 is also connected to the Internet 5 via a data line 39. Associated to the third server 30 is a user 60 which may e.g. be the operator of the server 30. The third server 30 may make part of an online marketing service provider whose main goal is to optimize an online shop's online advertisement budget.

A first client 40 is connected to the communications network, e.g. the Internet 5, via a data line 49. The client 40 may e.g. be designed as PC (personal computer) on which a browser 42 runs. The client 40 is moreover associated with a monitor 52, a keyboard 53, and a computer mouse 54, which permit interaction between a first user 50 and the client 40. It is feasible to design the client 40 as a so-called Set-Top-Box for a television or similar. The first user 50 represents a first number of network users making part of a group of users having at least one characteristic in common. Hence, it is understood that there are many first clients 40 connected to the network 5 with many first users 50 associated thereto, all belonging to a first number of network users. The characteristic the users of the group of users have in common comprises at least on of sex, age, place of domicile, nationality, marital status, number of children, special interests and hobbies, and online shopping behavior. The online shopping behavior may comprise a point in time and/or a period of time when the users last entered a certain online shop or entered the online shop for the first time.

A second client 40a is connected to the communications network, e.g. the Internet 5, via a data line 49a. The client 40a may e.g. be designed as PC (personal computer) on which a browser 42a runs. The client 40a can moreover be associated with a monitor 52a, a keyboard 53a, and a computer mouse 54a, which permit interaction between a second user 50a and the client 40a. It is feasible to design the client 40a as a so-called Set-Top-Box. The second user 50a represents a second number of network users making part of the group of users having at least one characteristic in common. Hence, it is understood that there are many second clients 40a connected to the network 5 with many second users 50a associated thereto, all belonging to a second number of network users.

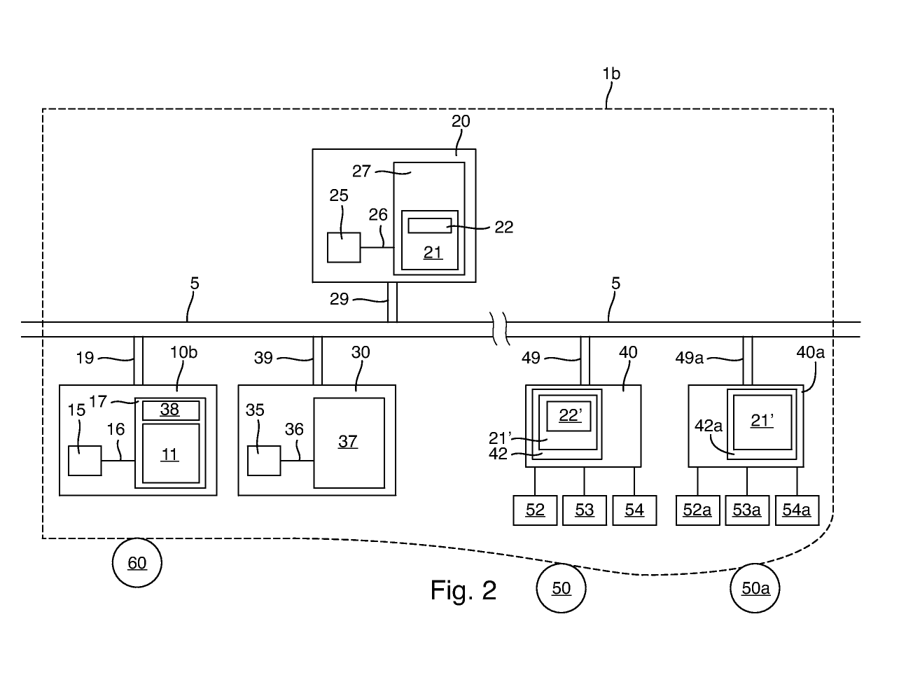

FIG. 2 shows a computer system 1b which is similar to computer system 1a shown in FIG. 1. The computer system 1b comprises a first server 20, a second server 10b and two clients 40, 40a. The functionality of the inventive server is again realized by the computer program 38. The computer program 38 is, however, stored in the computer system 1b in the storage element 17 of the second server 10b thereby realizing the functionality of the third server 30 of FIG. 1 also within the second server 10b (FIG. 2). FIG. 2 also shows a user 60 associated to the second server 10b. The user 60 may e.g. be the operator of the first server 10b.

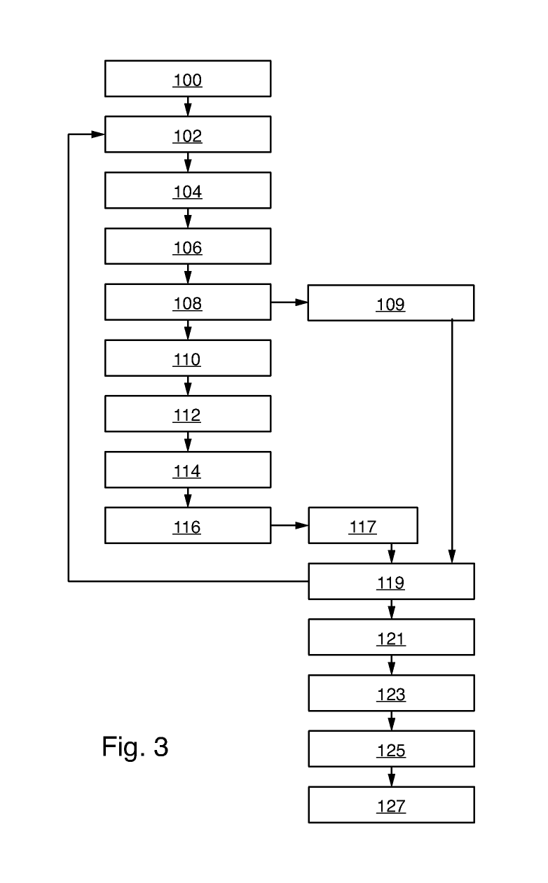

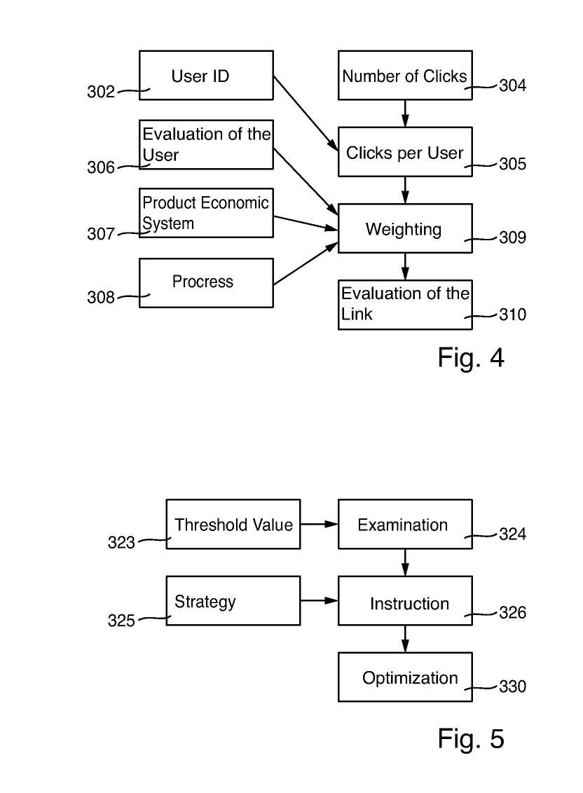

FIGS. 3 and 4 show examples for execution of the inventive method which is suitably based on the following scenario:

The user 60 operates the third server 30 (embodiment of FIG. 1) or the first server 10b (embodiment of FIG. 2) via which the users 50, 50a can order products or services. The first server 20 provides a network page 21 to be requested by the users, the web page 21 containing an online advertisement 22 possibly associated to a link to the second network page 11. This first network page 21 may e.g. be a purchasing port which represents the online advertisement or link 22 in dependence on a desired service or a certain branch. Alternatively, the first network page 21 could also be a SERP. The first network page 21 can, of course, also be accessed via further links (not shown) on further network pages (not shown).

The method starts with step 100. In step 102, the user 50 requests the first network page 21 from the first server 20 via the client 40. This may occur e.g. through direct input of the URL associated with the first network page 21 or by activating a further link on a further network page. Additionally, in step 102, the user 50a requests the first network page 21 from the first server 20 via the client 40a. The users 50, 50a can request the first network page 21 contemporaneously or time shifted.

In step 104, the first server 20 causes transmission of the first network page 21 to the clients 40, 40a. In step 106, the first network page 21 is interpreted by the browsers 42, 42a and is displayed to the users 50, 50a via the monitors 52, 52a. The displayed network page has the reference sign 21′ in FIGS. 1 and 2. It can be seen from FIGS. 1 and 2 that the network page 21′ displayed to the first user 50 shows the online advertisement 22 (the displayed advertisement has the reference sign 22′). The online advertisement 22 may be associated with a link leading to further textual or graphical information which e.g. describes and graphically shows a product or service. In contrast thereto, the network page 21′ displayed to the second user 50a does not show the online advertisement 22′. It is controlled by the computer program 38 to which users 50, 50a the online advertisement 22 is to be presented on the requested first network page 21 and to which users 50, 50a not. In this case the online advertisement 22 is presented to the first number of users 50 and not presented to the second number of users 50a.

In step 108, the first user 50 activates the link 22′ e.g. through pressing a key disposed on the mouse 54 (so-called click) causing the first client 40 to request the second network page 11 from the second server 10a, 10b (step 110) and transfer it to the client 40. The client 40 thereby communicates with the second server 10a, 10b e.g. via the data line 49, the Internet 5 and the data line 19. Alternatively, the second network page 11 can also be requested by the first user 50 by simply entering the respective URL into the browser 42 or by any other possible way. Similarly, the second user 50a requests the second network page 11 causing the second client 40a to request the second network page 11 from the second server 10a, 10b (step 110) and transfer it to the client 40a. The client 40a thereby communicates with the second server 10a, 10b e.g. via the data line 49a, the Internet 5 and the data line 19.

Activation of the link 22′ by the first user 50 as well any other request of the second network page 11 by the users 50, 50a also causes the browsers 42, 42a to transfer information to the third server 30, 38 in step 109. This information is e.g. the URL of the first network page 21, the URL of the second network page 11 requested by the users 50, 50a, information with respect to a product, a product group, a service or a group of services associated with the online advertisement 22′ (product identification), and optionally information which is suitable to identify the users 50, 50a (user identification). The information for identifying the users 50, 50a can be, for example, a user ID contained in a cookie stored on the clients 40, 40a.

The second server 10a, 10b causes the clients 40, 40a to set a cookie in step 112. A cookie is a small file which is locally stored on the clients 40, 40a and contains information which gives e.g. information about the first network page 21, the second network page 11 and/or the users 50, 50a. Of course, the cookie can contain alternative or different information, too, for example, regarding the user's behavior in the realm of the second network page 11 (e.g. the time the user 50, 50a remains in the realm of the second server 10a, 10b looking at the products and services offered by the online shop, a number of products and services the user 50, 50a looks at, an overall turnover generated by the user 50, 50a in the online shop by buying certain products and/or services at the online shop). Furthermore, setting of a cookie can also be caused by one of the other servers 20, 30.

The users 50; 50a may select further network pages offered by the second server 10a, 10b in step 114. These further network pages may typically be directly or indirectly accessed via links shown on the second network page 11 or other network pages. The further network pages offer e.g. further products, services or information, for example, for buying these products and services.

The users 50, 50a may order products or services or requests information in step 116 which may be effected e.g. through activation of a software realized virtual button provided therefore which is shown on a network page in the browser and entering user information, e.g. name and address and billing details of the user 50; 50a. This information is entered by the users 50, 50a by means of the keyboard 53, the mouse 54 or other input devices available at the clients 40, 40a but not shown in the figures. Then, the information is transmitted to the second server 10a, 10b via the Internet 5. Of course, it is also possible that the user information is already stored in a database accessible by the second server 10 and simply loaded from the database for the users 50, 50a for effecting the purchase. To this end, the users 50, 50a could be identified by the second server 10 by means of information previously stored in a cookie on the clients 40, 40a. Then, the user information of the identified users 50, 50a can be loaded from the database. This saves storage space and processing power at the clients 40, 40a.

In step 117, the clients 40, 40a cause transfer of the data stored in the cookie to the first server 10a, 10b and/or the third server 30, 38. Data transmission of the content of the cookies or of the information associated with the cookies and stored somewhere else may also be requested by the servers 10a, 10b, 30, 38. It is possible to recognize through the cookies e.g. whether the user 50 which carries out an order in step 116, has reached the second network page 11 via the link of the online advertisement 22 shown on the first network page 21 or has requested the second network page 11 in a different manner, e.g. by directly entering the URL. The cookies typically also comprise date and running time. The date shows when the cookies were set. After expiration of the running time, the cookies should automatically be deleted from the clients 40, 40a. The running time consequently determines the period which can lapse between setting of the cookies, i.e. request of the first network page 21, and e.g. ordering of a product, within which request of the first network page 21 and possibly activation of the link 22′ shall be associated with the users 50, 50a ordering the product.

In step 119 each user 50 of the first number of users and each user 50a of the second number of users is assessed with respect to at least one criteria. The criteria comprises at least one of whether the user enters the online shop at all, how long the user remains in the online shop, and an overall or an average turnover generated by the user in the online shop. When assessing the users 50, 50a the data transmitted in steps 109 is taken into consideration. For example, all requests of the second network page 11 by the users 50, 50a could be added up within a predeterminable time period. Alternatively or additionally further mathematical methods could be applied in order to assess the users 50, 50a, in particular based on the information from the cookies.

Then, in step 121 the effectiveness of the online advertisement 22′ displayed to the client 50 on the first network page 21′ is determined based on the result of the assessment of the users 50, 50a. This is performed in particular by comparing the user assessment results for the first number of users 50 with the user assessment results for the second number of users 50a. Hence, the following scenarios are possible:
a) The presentation of the online advertisement 22′ to the first number of users 50 has no or only a relatively small positive effect on the turnover achieved in the online shop (second server 10a, 10b) in respect to the second number of users 50a, which were not shown the online advertisement 22′.
b) The presentation of the online advertisement 22′ to the first number of users 50 has a relatively large positive effect on the turnover achieved in the online shop (second server 10a, 10b) in respect to the second number of users 50a, which were not shown the online advertisement 22′.
c) The presentation of the online advertisement 22′ to the first number of users 50 has a very large positive effect on the turnover achieved in the online shop (second server 10a, 10b) in respect to the second number of users 50a, which were not shown the online advertisement 22′.

Of course, instead of the turnover generated in the online shop 10a, 10b by the first and second number of users 50, 50a any other parameter, e.g. the return of investment or the conversion rate, adapted for measuring the effect of the online advertisement 22′ can be used. A combination of several parameters is possible, too. Furthermore, external factors, e.g. date, time, weather or season, can be considered, too. A combination of one or more parameters and one or more external factors can be considered, too. Finally, the determination of the effectiveness of the online advertisement 22′ can also be carried out by taking into consideration and depending on the data of a merchandise information system.

In step 123 the results of the determination of the effectiveness of the online advertisement 22 are provided to the user 60, e.g. an operator of the third server 30 (in the embodiment of FIG. 1) or of the second server 10b (in the embodiment of FIG. 2). The user 60 can be, for instance, an employee working for an online marketing service provider who hosts the third server 30 or the second server 10b. The results obtained in step 121 may also be stored in a region of the storage element 37 of the third server 30 or in a region of the storage element 17 of the second server 10b, wherein the user 60 or a third party (e.g. an operator from the online shop) has access to these results.

The results are provided to the user 60 in step 123 e.g. via an automatically generated e-mail. Alternatively, a graphical user interface (GUI) on a personal computer associated to the user 60 can be provided, and the results obtained in step 121 can be displayed graphically or textually to the user 60 by means of the GUI. By means of the GUI and a corresponding computer program running on the personal computer or a server connected to the communications network 5, the user 60 has also the possibility to control the online advertising activities of his clients. In particular, bidding for certain keywords for different search engine providers and/or different content providers can be monitored and/or controlled by means of the GUI and the corresponding computer program.

In step 125 it is determined whether, based on the results of the determination of the effectiveness of the online advertisement 22, for future requests of the first network page 21 by the users 50, 50a any changes should be effected in the presentation of the online advertisement 22. In particular, it could be decided to change the presentation of the online advertisement 22 if the presentation of the online advertisement 22′ on the first network page 21′ proves to be ineffective or does not achieve the desired level of effectiveness (e.g. because a desired conversion rate or turnover in the online shop is not achieved). For example, if the second number of users 50a creates very low conversion rates or almost no turnover in a predetermined period of time in respect to the first number of users 50, the online advertisement 22′, which was only shown to the first number of users 50 has proved to be efficient. For future requests of the first network page 21 one could continue to present the online advertisement 22′ together with the network page 21′ to the users 50 requesting the first network page 21. This can be achieved by maintaining or even increasing the maximum bidding offer in an online keyword bidding system.

However, if the second number of users 50a creates conversion rates or a turnover in a predetermined period of time, which are similar to those created by the first number of users 50, the online advertisement 22′, which was not shown to the second number of users 50a seems to have not much influence on the users 50, 50a online shopping behavior and, therefore, can be considered as more or less inefficient. For future requests of the first network page 21 one could no longer present the online advertisement 22′ together with the network page 21′ to the users 50 requesting the first network page 21 or show the online advertisement 22′ with a lower ranking on the network page 21′. This can be achieved by reducing the maximum bidding offer (even down to zero) in an online keyword bidding system. Alternatively, an inefficient online advertisement could be presented to the users 50 on another network page. This other network page could be of the same search engine or content provider or it could be a network page from a different search engine or content provider. This can be achieved in an online keyword bidding system by shifting online advertisement expenditure at least partly from a previous keyword to another keyword (displaying the banner on another network page of the same content provider). Alternatively or additionally, the online advertisement expenditure for a certain keyword could be shifted at least partly from a previous online keyword bidding system to another online keyword bidding system (displaying the banner on another network page of a different content provider).

For example, it may well be that the user's interest in the online advertisement 22′ will increase in the sense of resulting in higher conversion rates or a higher turnover if the online advertisement 22′ is presented to the user 50 on the first network page 21′ associated to a certain search engine (e.g. Google®) instead of on the first network page 21′ associated to a certain company (e.g. T-Mobile®). Furthermore, it may well be that the user's interest in the online advertisement 22′ will increase if it is presented to the user 50 on the first network page 21′ associated to a first search engine (e.g. Google®) instead of on the first network page 21′ associated to a second search engine (e.g. Yahoo!®). Further, it may well be that the user's interest in the online advertisement 22′ will increase in the sense of resulting in higher conversion rates or a higher turnover if the online advertisement 22′ is presented to the user 50 on the first network page 21′ associated to a social media (e.g. Facebook®) instead of on the first network page 21′ associated to a search engine provider (e.g. Google®). Finally, the presentation of the online advertisement may be optimized by changing the type of advertisement to another type. For example, it may well be that under certain circumstances (e.g. for the selected group of network users 50, 50a; for certain products and services; for certain types of online shops, etc.) contextual ads on search engine results pages prove to be more efficient than banner ads. This can be achieved by shifting the online advertisement expenditure at least partly from a previous online banner bidding system to an online contextual adds bidding system (displaying a contextual add instead of a banner on the first network page).

In the embodiment shown in FIG. 3, step 127 represents the various possible actions which can be taken in response to the results of the determination of the effectiveness of the online advertisement 22′) in step 121, in order to optimize the online advertisement 22′, in particular to increase its effectiveness. In the embodiment of FIG. 3 the actions of step 127 are preferably prepared and/or triggered manually by the user 60. Of course, it would also be possible that the step 127 is automatically executed. In that case the computer program according to the present invention would have appropriate algorithms in order to take a decision which action to take in order to increase the relevance of the online advertisement. In particular, this would comprise defining a maximum bidding offer to provide to an online bidding system for a certain type of online advertisement on a certain network page. Appropriate templates could be programmed which insert the defined maximum bidding offers to the appropriate online bidding system, which then would automatically take into consideration these maximum bidding offers for the next allocation of advertising space on the appropriate network page.

The described method can be continuously executed as long as the online shop 10a, 10b wants to advertise and as long as the online marketing service provider 30 (in FIG. 1) or 10b (in FIG. 2) perform an optimization of the online shop's advertisement expenditures. The present invention provides for an automatic advertisement budget allocation which is not limited to the same content service provider but which can comprehensively allocate the advertisement budget between a plurality of different content service providers.

Due to the plurality of possible adjustments to segments and targeting, the invention can also provide for an automatic advertising asset allocation and portfolio reallocation, for example by means of an appropriate algorithm. This works similar to a customer's stock portfolio, where the customer's investment is continuously optimized by assessing various potential stock companies, selecting the most successful companies and finally shifting the investment at least partially from one stock company to another. If, for example, for a certain client a certain budget (e.g. EUR 100,000.00) is used for a certain targeting campaign comprising, for example, EUR 50,000.00 for Google®, EUR 25,000.00 for Facebook®, EUR 10,000.00 for Yahoo!® and EUR 15,000.00 for T-Online, the success of the campaign can be constantly monitored by means of the method according to the present invention. In particular, the effectiveness of the various types of online advertisement are constantly determined. If, for example, it is ascertained that the investment spent for T-Online is not very efficient, it would be possible to simply no longer display the online advertisement with T-Online and to simply save the money. On the other hand, it would also be possible to reallocate the money to another service provider, for example, as an additional investment to the already existing content providers (Google®, Facebook®, Yahoo!®) or to a completely new service provider (e.g. Twitter®). Hence, according to the performance of the online advertisement with a certain publisher, the advertisement expenditure or advertising allocation is continuously optimized in order to achieve the maximum outcome.

FIG. 4 shows the step of determining the effectiveness of the online advertisement 22 in a schematic and exemplary manner. A user identification is provided as part of the user assessment step 119 by a function unit 302 which permits association of each request of the first network page 21 with the user requesting the page 21, e.g. one of the users 50, 50a.

If the online advertisement 22 is associated with a link, the number of all activations of the link carried out within a predeterminable time period is determined and provided in a function unit 304 using e.g. the data transmitted in step 109 of FIG. 3.

The number of activations of the link associated to the online advertisement 22 per user 50, 50a is determined in a function unit 305. Towards this end, the total number of activations from the function unit 304 and the user identification from the function unit 302 associated with each activation are used. The same would apply, if the first network page 21 was not requested via a click but, for example, by entering the appropriate URL into the browser 42, 42a.

The function unit 306 provides assessment of a user, e.g. one of the users 50, 50a. Assessment of the user 50, 50a may e.g. involve the payment reliability or products or product groups (books, food, etc.) which this user 50, 50a orders very frequently. Alternatively, the assessment of the user 50, 50a may involve the conversion rate (The conversion rate is the proportion of visitors to a website who take action to go beyond a casual content view or website visit, as a result of subtle or direct requests from marketers, advertisers, and content creators.). Successful conversions are defined differently by individual marketers, advertisers, and content creators. To online retailers, for example, a successful conversion may be defined as the sale of a product to a consumer whose interest in the item was initially sparked by clicking the link associated with the online advertisement 22 (e.g. a banner advertisement). To content creators, a successful conversion may refer to a membership registration, newsletter subscription, software download, or other activity.

Information regarding the ordered products and/or services and provided by a merchandise information system is provided in a function unit 307. The function unit 308 suitably processes and provides information about the process shown in step 116 of FIG. 3 (e.g. order of a product, selection of further network pages 11 from the first server 10a, 10b). Towards this end, the function unit 308 uses e.g. the data transmitted in step 117 of FIG. 3. The function unit 308 may provide information for each finished process concerning the type of process (order/purchase of information, goods, services, etc.), the turnover achieved and the user 50, 50a.

A function unit 309 weights the activations of the link 22 per user using information provided by the function units 305, 306, 307 and 308, wherein the activations carried out by a user A are e.g. not assessed if the user A has not ordered (0·a). The number of activations b of the link 22 carried out by a user B is e.g. assessed as of little importance if the user B is constantly in arrears with payment (0.5·b). The activations c of the link 22 carried out by a user C are assessed as highly important if the user C effects particularly high turnovers via the network pages of the first server 10a, 10b (2·c).

The actual determination of the effectiveness of the online advertisement 22 is carried out in the function unit 310 through suitable combination of the information provided by the function unit 309. This is effected e.g. through addition of the data provided by the function unit 309 (0·a+0.5·b+2·c). The online advertisement 22 may, of course, also be weighted and assessed exclusively through information from the merchandise information system of the function unit 307.

FIG. 5 schematically shows function units which can be used to optimize the online advertisement 22. A function unit 324 examines whether the assessed advertisement 22 shall be optimized using a threshold value provided by the function unit 323. If the function unit 324 determines that the assessment of the link 22 is below the threshold value provided by the function unit 323, the function unit 324 may effect optimization of the online advertisement 22. Towards this end, instructions are generated in a function unit 326 in dependence on a strategy provided by a function unit 325. This is performed in step 127 of FIG. 3.

If the online advertisement 22 is e.g. associated with a number of search terms on a search engine, the strategy may provide removal or exchange of individual search terms associated with a product or a product group within a product database. Alternatively, the strategy may comprise an increase or a decrease of a maximum price offered for a keyword associated with the online advertisement 22, thereby possibly leading to a change of a position in which the advertisement 22 is presented to the users 50, 50a on the first network page 21 or possibly even leading to no longer displaying the advertisement 22 on the network page 21.

The function unit 326 generates instructions of a suitable format in dependence on the strategy which is transmitted to the first server 20. A suitable format may e.g. be instructions for a database located on the first server 20, e.g. SQL (Structured Query Language). The database may e.g. be the product database or communicate with the product database.

The online advertisement 22 is optimized in a function unit 330. Towards this end, the instructions generated by the function unit 326 are carried out, such as e.g. removal from or change of the position of the online advertisement 22 of the database associated with the first server 20 or change of the search terms associated with a product or a product group, and increase or decrease of the maximum bidding price for search terms associated with the online advertisement 22.

It is, of course, possible to also take into consideration further information for the assessment 310 of the online advertisement 22, examination 324 of the assessment or generation 326 of the instructions, which involves, in particular, the above-mentioned information concerning the product, product group, service and/or group of services.

The result of the examination generated by the function unit 324 may also be provided in a suitable form (e.g. via e-mail or via a port) to the user 60 for information purposes and possible assessment of the online advertisement 22. In this case, the user 60 could effect a manual optimization of the online advertisement 22.

Another embodiment could provide assessment of the online advertisement 22 without weighting 309. In this case, the function units 309 and 306 could be omitted.

It is possible to change or omit individual steps or add new steps in the flow charts shown in FIG. 3 of an embodiment of the inventive method. Several cookies from the first server 20, the second server 10a, 10b, and/or third server 30, 38 may be set in the client 40, 40a for the user 50, 50a which would provide an even more exact analysis of the behavior of the user 50, 50a and more precise optimization of the online advertisement 22 shown on the first network page 21.

What is claimed:

1. A method for determining effectiveness of an online advertisement displayed on a first network page, the advertisement referring to at least one of an online shop, a product and a service offered by an online shop, the method comprising the steps of:
selecting by at least one by computer a group of network users;
presenting by the at least one computer the online advertisement to a first number of users of the group of network users requesting the first network page, thereby storing a cookie on each client of the first number of users, each cookie comprising a unique user ID for the respective user;
not presenting by the at least one computer the online advertisement to a second number of users of the group of users requesting the first network page, thereby storing a cookie on each client of the second number of users, each cookie comprising a unique user ID for the respective user;
assessing by the at least one computer each user of the first number of users and of the second number of users with respect to at least one criteria; and
based on results of the assessment of the users, determining by the at least one computer the effectiveness of the online advertisement on the first network page by comparing the user assessment results for the first number of users with the user assessment results for the second number of users.

2. A method according to claim 1, wherein the online advertisement is one of a textual, graphical or audio advertisement.

3. A method according to claim 2, wherein the online advertisement is one of contextual ads on search engine results pages, banner ads, blogs, rich media ads, social network ads, interstitial ads, online classified ads, advertising spots, and advertising networks.

4. A method according to claim 1, wherein the online advertisement comprises or is associated to a link to a second network page of the online shop to which the online advertisement refers to.

5. A method according to claim 1, wherein the users are assessed according to the criteria comprising at least one of whether the user enters the online shop at all, how long the user remains in the online shop, and a turnover generated by the user upon entry into the online shop.

6. A method according to claim 1, wherein the first network page is presented to a user, by entering a network address associated to the first network page into a browser running on the user's client, by clicking on a hyperlink displayed on another network page previously presented to the user or by automatically forwarding the user from another network page previously presented to the user to the first network page.

7. A method according to claim 1, wherein the group of network users is determined such that all users of the group have at least one characteristic in common.

8. A method according to claim 7, wherein the characteristic for selecting the group of users comprises at least one of sex, age, place of domicile, nationality, marital status, number of children, special interests and hobbies, and online shopping behavior.

9. A method according to claim 1, wherein the step of assessing each user of the first number of users and of the second number of users is performed based on information stored in the cookies.

10. A method according to claim 9, wherein the cookies contain information about at least one of the first network page and the user.

11. A method according to claim 8, wherein the step of assessing each user of the first number of users and of the second number of users is performed based on the characteristic for selecting the group of users.

12. A method according to claim 1, wherein the first number of users and the second number of users is approximately the same.

13. A method according to claim 1, wherein, based on the effectiveness of the online advertisement, determining for future requests of the first network page whether to present the online advertisement to a user requesting the first network page or not.

14. A method according to claim 13, wherein in case for future requests of the first network page the online advertisement is not presented to a user requesting the first network page, the online advertisement is presented to a user requesting another network page.

15. A method according to claim 1, wherein, based on the effectiveness of the online advertisement, biddings for presenting the online advertisement on the first network page are determined and placed at an online bidding system.

16. A method according to claim 1 wherein the at least one computer includes a computer readable storage device containing instructions for controlling the method of claim 1.

17. A computer system for determining effectiveness of an online advertisement displayed on a first network page, the advertisement referring to at least one of an online shop, a product and a service offered by an online shop, the system comprising:
a first computer for selecting a group of network users;
the first computer presenting the online advertisement to a first number of users of the group of network users requesting the first network page and for not presenting the online advertisement to a second number of users of the group of users requesting the first network page,
at least one second computer for storing a cookie on each client of the first number of users and of the second number of users, each cookie comprising a unique user ID for the respective user;
the at least one second computer assessing each user of the first number of users and of the second number of users with respect to at least one criteria; and
the at least one second computer determining the effectiveness of the online advertisement on the first network page, based on results of the assessment of the users, by comparing the user assessment results for the first number of users with the user assessment results for the second number of users.

18. A computer system according to claim 17, including a communications network connected to the first computer and the at least one second computer.

19. A computer system according to claim 18, wherein said communications network is one of an Internet and a private local area network.

20. A device for determining effectiveness of an online advertisement displayed on a first network page, the advertisement referring to at least one of an online shop, a product and a service offered by an online shop, the device comprising:
a first server for controlling selection of a group of network users;
the first server controlling presentation of the online advertisement to a first number of users of the group of network users requesting the first network page and for controlling non-presentation of the online advertisement to a second number of users of the group of users requesting the first network page,
at least one second server for controlling storage of a cookie on each client of the first number of users and of the second number of users, each cookie comprising a unique user ID for the respective user;
the at least one second server assessing each user of the first number of users and of the second number of users with respect to at least one criteria; and
the at least one second server determining the effectiveness of the online advertisement on the first network page, based on results of the assessment of the users, by comparing the user assessment results for the first number of users with the user assessment results for the second number of users.

21. A device according to claim 20, including a communications network connected to the first server and the at least one second server.
